(19) United States
(12) Patent Application Publication
(10) Pub. No.: US 2019/0313024 A1
(43) Pub. Date: Oct. 10, 2019

(54) CAMERA POWER MANAGEMENT BY A NETWORK HUB WITH ARTIFICIAL INTELLIGENCE

(71) Applicant: Deep Sentinel Corp., Pleasanton, CA (US)

(72) Inventors: David Lee Selinger, Pleasanton, CA (US); Chaoying Chen, Dublin, CA (US); Kandarp Nyati, San Jose, CA (US)

(21) Appl. No.: 15/948,531

(22) Filed: Apr. 9, 2018

(51) Int. Cl. H04N 5/232; G08B 13/196; G05B 13/04

(52) U.S. Cl. CPC H04N 5/23241; G08B 13/19602; H04N 5/23296; G05B 13/042; G05B 13/048; G08B 13/19636

(57) ABSTRACT

Apparatus and associated methods relate to a network hub receiving from a video source video frames selected as a function of a video characteristic, determining a degree of interest of the selected video frames predicted as a function of artificial intelligence configured in the network hub, and automatically governing the video source operating parameters based on the degree of interest. In an illustrative example, the video source may be a camera. The video characteristic may be, for example, motion. In various implementations, video frames received by the network hub may be selected based on motion detection, and the video source may be, for example, a camera configured to detect motion in video frames captured by the camera. Various examples may advantageously provide improved camera power management, for example, using the degree of interest predicted by the artificial intelligence configured in the network hub to govern operational parameters of the camera.

### TECHNICAL FIELD

Various embodiments relate generally to camera power management.

### BACKGROUND

Cameras are generally composed from visual imaging devices. Some visual imaging devices capture optical images based on receiving light through a lens. Cameras may convert received light to a form that can be stored or transferred. For example, a digital camera may employ a sensor to convert received light to digital data that may be stored or transferred to a server or database as data file which may be known as image data. Some cameras are used to capture images of potential interest. For example, a security camera may be oriented to capture images of an area to be protected, such as a home entrance in the visual field of the camera.

Some cameras are configured with wireless communication interfaces. A camera with a wireless communication interface may be deployed without wired communication links to a location remote from a server or database. Some cameras may be able to capture and transfer an image to a server in response to motion detected by the camera in the camera's visual field. Cameras configured to operate in remote locations may be battery powered. Battery-powered cameras configured to operate at remote locations may have limited battery life. Battery replacement may be inconvenient at some remote camera locations. The useful battery lifetime may limit the usefulness of battery-powered cameras in some locations. Some wireless battery-operated cameras are capable of conserving battery lifetime by powering up for a limited on-time to capture or transfer an image when motion is detected.

Images captured by a camera may be studied by a human or a machine to identify the image content. Some images may contain a representation of an object. Machines may be trained to identify objects represented in an image using techniques from the fields of image processing, machine learning, and artificial intelligence (AI). Machines that are trained to identify objects may be known as artificial intelligence. Some artificial intelligence may be trained to identify a specific individual and classify the individual according to the threat posed by the individual. Object identification by artificial intelligence based on captured images may require substantial computation. Rapid response to threats posed by some identified objects may be necessary.

### SUMMARY

Apparatus and associated methods relate to a network hub receiving from a video source video frames selected as a function of a video characteristic, determining a degree of interest of the selected video frames predicted as a function of artificial intelligence configured in the network hub, and automatically governing the video source operating parameters based on the degree of interest. In an illustrative example, the video source may be a camera. The video characteristic may be, for example, motion. In various implementations, video frames received by the network hub may be selected based on motion detection, and the video source may be, for example, a camera configured to detect motion in video frames captured by the camera. Various examples may advantageously provide improved camera power management, for example, using the degree of interest predicted by the artificial intelligence configured in the network hub to govern operational parameters of the camera.

Various embodiments may achieve one or more advantages. For example, some embodiments may improve the battery lifetime of battery-powered cameras. This facilitation may be a result of cutting short the fixed on-time of a motion-detecting battery-powered camera, in response to determining the type of object in the image processed by artificial intelligence. For example, camera triggering may be suppressed for a period of time, in response to detection of objects classified as uninteresting by the artificial intelligence. In some embodiments, security system response time may be reduced. Such reduced security system response time may be a result of artificial intelligence automatically determining a degree of interest of images captured in response to motion detected by the camera. Some embodiments may increase the accuracy of object identification. Such increased identification accuracy may be a result of automatic adjustments to illumination levels by the artificial intelligence in response to automatic analysis of captured image quality metrics.

In some designs, the object classification error rate may be reduced. This facilitation may be a result of automatic adjustments to bitrate by the artificial intelligence in response to automatic analysis of quality metrics of captured images. In some embodiments, the latency required to detect a threat in a captured image may be reduced. Such reduced threat detection latency may be a result of streaming video frames with detected motion from a camera to a hub configured with artificial intelligence adapted to identify objects and classify objects by type. In various designs, the usability of security threat notifications may be increased. This facilitation may be a result of filtering notifications to a homeowner based on the object type determined by artificial intelligence as a function of an image captured by the camera. In some implementations, camera object tracking accuracy may be increased. Such comprehensive increased camera object tracking may be a result of the hub controlling camera pan, tilt, zoom, or focus in response to object types determined by the artificial intelligence as a function of an image captured by the camera. For example, in response to classification by the artificial intelligence of a human as a burglar, the hub may direct the camera to focus on and follow the burglar's movement around the home. Such improved object tracking may enable the hub to provide the burglar's location within the home to law enforcement, enabling a more robust police response.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts a collaboration view of an exemplary network hub receiving from a video source video frames selected as a function of a video characteristic, determining a degree of interest of the selected video frames predicted as a function of artificial intelligence configured in the network hub, and automatically governing the video source operating parameters based on the degree of interest.

FIG. 2 depicts a process flow of an exemplary Video Scene Learning Engine (VSLE).

FIG. 3 depicts a process flow of an exemplary Video Scene Prediction Engine (VSPE).

Like reference symbols in the various drawings indicate like elements.

### DETAILED DESCRIPTION OF ILLUSTRATIVE EMBODIMENTS

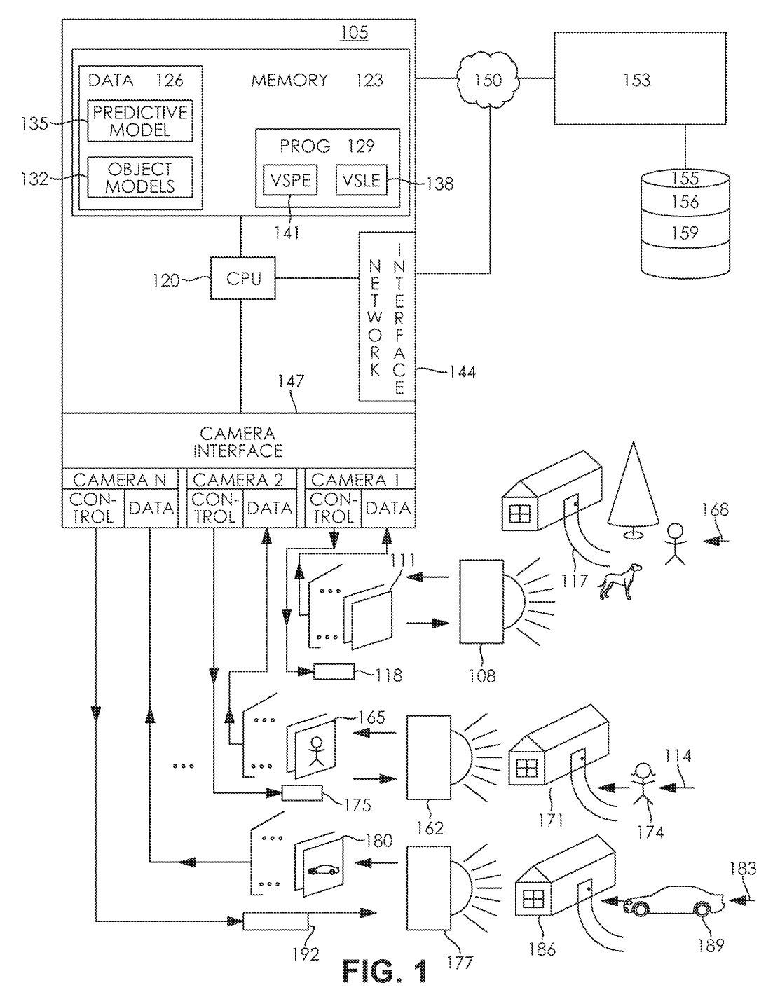

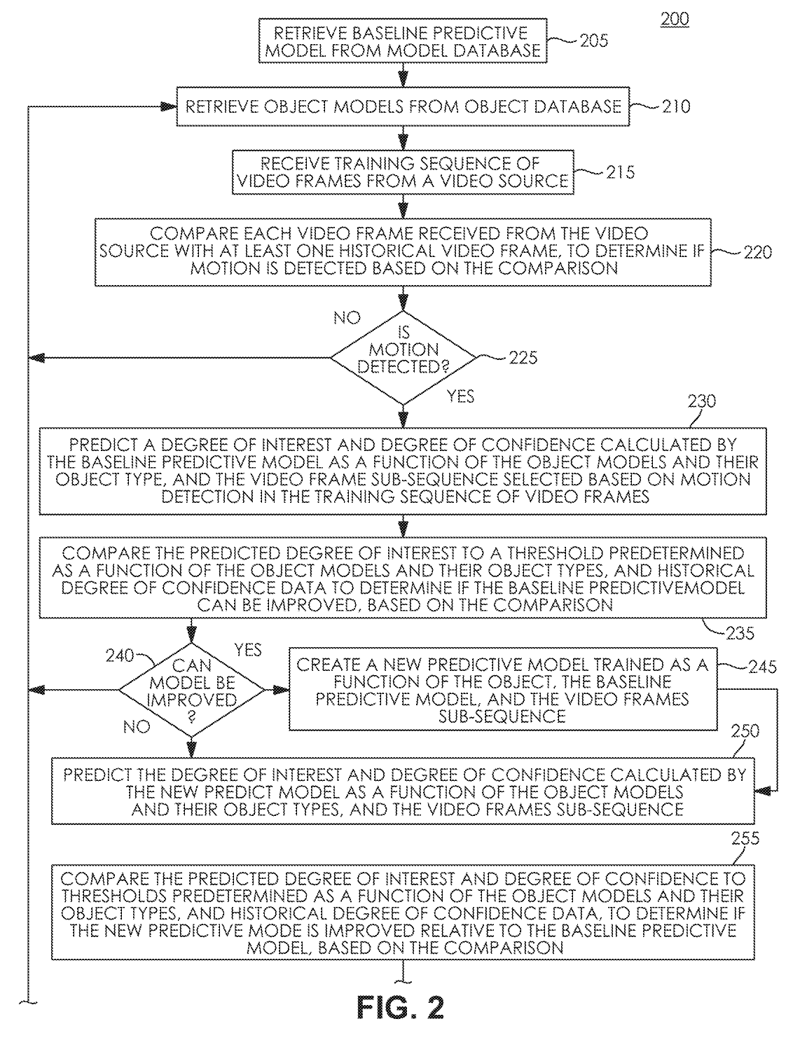

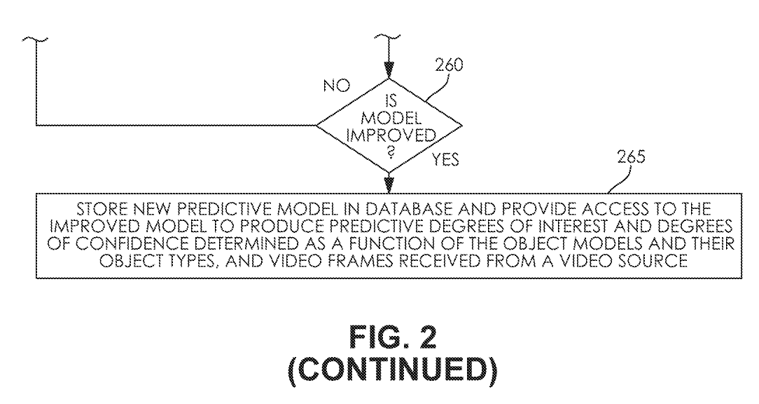

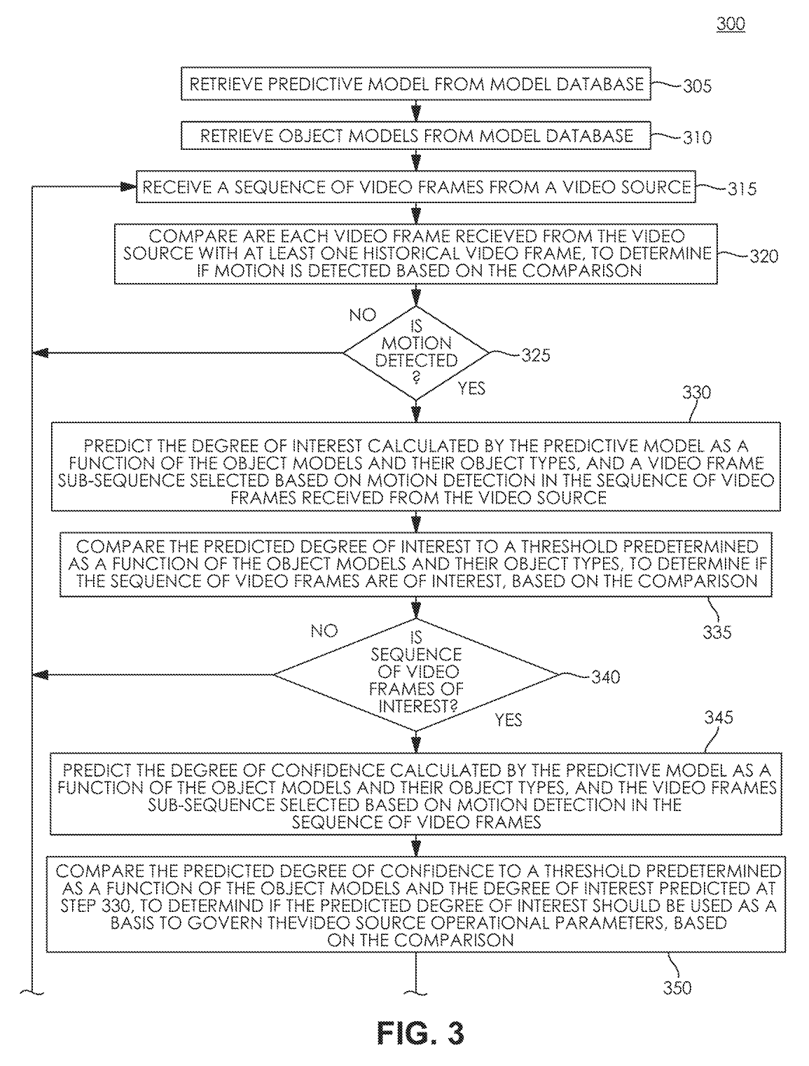

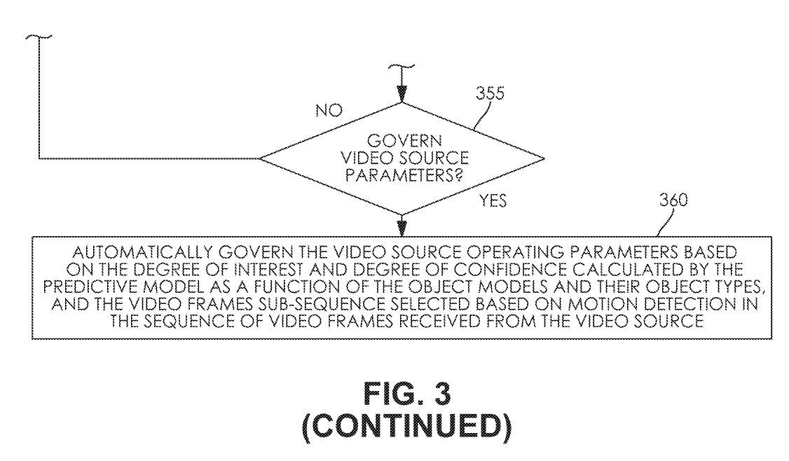

To aid understanding, this document is organized as follows. First, automatically governing operating parameters of an illustrative video source based on the degree of interest determined by an exemplary artificial intelligence configured in an embodiment network hub is disclosed with reference to FIG. 1. Then, with reference to FIG. 2, the discussion turns to exemplary embodiments that describe evaluating and training an illustrative predictive model useful to determine the degree of interest of video frames received from a video source. Specifically, an exemplary process to train an improved predictive model is disclosed. Finally, with reference to FIG. 3, an exemplary process to automatically govern video source operating parameters based on a video frame degree of interest is presented.

FIG. 1 depicts a collaboration view of an exemplary network hub receiving from a video source video frames selected as a function of a video characteristic, determining a degree of interest of the selected video frames predicted as a function of artificial intelligence configured in the network hub, and automatically governing the video source operating parameters based on the degree of interest. In FIG. 1, exemplary network hub 105 receives training video frames 111 selected by the video source 108 as a function of the video characteristic 114 detected by the video source 108 in the training scene 117. In the depicted embodiment, the training video source 108 is a battery-powered camera configured to detect motion. In the illustrated embodiment, the video characteristic 114 detected by the video source 108 is motion in the training scene 117. In the illustrated embodiment, the network hub 105 trains an artificial intelligence to predict a degree of interest and object type of objects detected by the network hub 105 as a function of the training video frames 111. In the illustrated embodiment, the network hub 105 governs the operational parameters of video sources connected to the network hub 105 based on the degree of interest and object type of objects detected by the network hub 105. In the illustrated embodiment, the governed operational parameters of the video sources include camera on-time. In the depicted embodiment, the network hub 105 manages the power consumption of cameras connected to the hub based on automatically governing the video source operating parameters based on the degree of interest. In the illustrated embodiment, a hub-connected camera configured to detect motion transitions from a power-conserving sleep mode with network interfaces, including wireless interfaces, powered down, to an operational, powered up mode, to begin streaming video frames to the hub in response to detected motion. In the depicted embodiment, the hub-connected camera remains fully powered on and streaming video frames to the hub, for a period of time configured in the camera, in response to motion detected by the camera. In the illustrated embodiment, the hub 105 predicts a degree of interest and object type of objects detected by the network hub 105 based on video frames received from the camera in response to motion detected by the camera. In the depicted embodiment, the artificial intelligence configured in the hub 105 may determine a low degree of interest in the video frames received from the camera. In the illustrated embodiment, the hub 105 may conserve camera battery power based on cutting short the camera on-time if, for example, the degree of interest is low. In the depicted embodiment, the network hub 105 includes processor 120 in electrical communication with memory 123. The depicted memory 123 includes data memory 126 and program memory 129. The data memory includes object models 132 and predictive model 135. The program memory includes processor-executable program instructions implementing VSLE (Video Scene Learning Engine) 138 and VSPE (Video Scene Prediction Engine) 141. In the depicted embodiment, the processor 120 is communicatively and operably coupled with the network interface 144. In some embodiments, the network interface 144 may be a wireless network interface. In various implementations, the network interface 144 may be a wired network interface. In some designs, the network interface 144 may include wired and wireless network interfaces. In the depicted embodiment, the processor 120 is communicatively and operably coupled with the camera interface 147. In the illustrated embodiment, the camera interface 147 is adapted to interface the hub 105 with more than one camera. In the depicted embodiment, the camera interface 147 includes a control path and a data path allocated to each camera. In the illustrated embodiment, each camera interface data path is adapted to receive video or image data from a camera. In the depicted embodiment, each camera interface control path is adapted to transmit control data to a camera. In the illustrated example, the video source 108 receives control data 118 from the hub 105. In the depicted example, the control data 118 includes an adjustment to camera on-time. Control data transmitted to a camera from the network hub 105 may be, for example, camera operational parameters governed by the hub, including such parameters as the camera on-time, or a command to power down the camera. In the illustrated embodiment, the artificial intelligence configured in the hub 105 includes predictive model 135 and object models 132. In the illustrated embodiment, the network hub 105 trains the predictive model 135 to predict a degree of interest and object type of objects detected by the network hub 105 as a function of the training video frames 111 and the object models 132. In the illustrated embodiment, the network hub 105 stores the trained predictive model 135 in the predictive model store 159 of cloud database 155 hosted by cloud server 153. In the depicted example, the network hub is communicatively coupled with the cloud server 153 via network cloud 150. In the illustrated embodiment, the network hub retrieves trained predictive models 159 from the cloud database 155 via cloud server 153 and network cloud 150. In the depicted embodiment, the video frames sub-sequence of training sequence 111 includes video frames representative of training scene 117 from video source 108. In the illustrated embodiment, training scene 117 includes visual objects representative of the homeowner's house, the homeowner's cat, a tree in the yard, and the homeowner approaching the house from the sidewalk. In the illustrated embodiment, the new predictive model is trained as a function of the visual objects including the homeowner's house, the homeowner's cat, a tree in the yard, and the homeowner. In the illustrated example, the new predictive model is trained to predict that the homeowner and the homeowner's cat are familiar and non-threatening. In the depicted embodiment, the hub 105 receives production sequences 165 and 180 of video frames from video sources 162 and video source 177, respectively. In the depicted example, video sources 162 and 177 are battery-powered cameras configured to power-on and stream video to a connected device in response to motion detected by the camera. In the illustrated example, the video frames 165 are selected by the video source 162 in response to motion 168 detected by the video source 162 in production scene 171. In the illustrated example, the video frames 180 are selected by the video source 177 in response to motion 183 detected by the video source 177 in production scene 186. In the illustrated embodiment, the hub 105 determines a high degree of interest in the approaching object 174 identified as a function of the predictive model 135, the object models 132, and the video frames 165. In the depicted embodiment, the approaching object 174 is identified as a human with high confidence, and the human is identified by the predictive model 135 as the homeowner the predictive model 135 was trained to identify in training scene 117. In the depicted example, the network hub 105 cuts short the camera 162 on-time via control data 175 sent to the video source 162 to conserve camera battery power. In the illustrated embodiment, the hub 105 determines a high degree of interest in the approaching object 189 identified as a function of the predictive model 135, the object models 132, and the video frames 180. In the depicted embodiment, the approaching object 189 is identified as a car with high confidence, however the car is not identified by the predictive model 135 as an object the predictive model 135 was trained to identify in training scene 117. In the depicted example, the network hub 105 increases the camera 177 on-time via control data 192 sent to the video source 177 to extend surveillance of the threatening object 189. In the depicted embodiment, the network hub sends notification of the threatening object 189 to the homeowner. In various implementations, the depicted memory 123 may contain processor executable program instruction modules configurable by the processor 120 to be adapted to provide image input capability, video encoding, video decoding, image output capability, image sampling, spectral image analysis, correlation, autocorrelation, Fourier transforms, image buffering, image filtering operations including adjusting frequency response and attenuation characteristics of spatial domain and frequency domain filters, or anomaly detection.

FIG. 2 depicts a process flow of an exemplary Video Scene Learning Engine (VSLE). In FIG. 2, an embodiment VSLE 138 process flow is depicted training an artificial intelligence configured in the network hub 105 to automatically determine a degree of interest of video frames selected by a video source as a function of a video characteristic detected by the video source. The method depicted in FIG. 2 is given from the perspective of the VSLE 138 executing as program instructions on processor 120 of network hub 105, depicted in FIG. 1. In some embodiments, the VSLE 138 may execute on cloud server 153 as a cloud service, governed by processor 120 via network cloud 150. The depicted method begins at step 205 with the processor 120 retrieving a baseline predictive model 135 from the predictive model database 159. The method continues at step 210 with the processor 120 retrieving object models 132 from the object model database 156. The method continues at step 215 with the processor 120 receiving a training sequence 111 of video frames representative of training scene 117 from video source 108. In the depicted embodiment, the training scene includes visual imagery representative of objects including the homeowner's house, the homeowner's cat, a tree in the yard, and the homeowner approaching the house from the sidewalk. In the depicted embodiment, the video source 108 is a camera. In some embodiments, the video source 108 may be a video stream source that is not a camera. The method continues at step 220 with the processor 120 comparing each video frame received from the video source with at least one historical video frame, to determine if a video characteristic of interest is detected based on the comparison. In some embodiments, the video characteristic of interest may be motion. In various implementations, motion may be detected by the camera. In some designs, motion may be detected by the hub 105. At step 225, a test is performed by the processor 120 to determine if motion was detected, based on the comparison performed by the processor 120 at step 220. Upon a determination by the processor 120 at step 225 that motion was not detected, the method continues at step 215 with the processor 120 receiving a training sequence 111 of video frames representative of training scene 117 from video source 108. Upon a determination by the processor 120 at step 225 that motion was detected, the method continues at step 230 with the processor 120 predicting a degree of interest and degree of confidence calculated by the baseline predictive model 135 as a function of the object models 132 and their object types, and a video frames sub-sequence of training sequence 111 selected based on motion detection in the training sequence of video frames. The method continues at step 235 with the processor 120 comparing the predicted degree of interest to a threshold predetermined as a function of the object models 132 and their object types, and historical degree of confidence data, to determine if the baseline predictive model 135 can be improved, based on the comparison. At step 240, a test is performed by the processor 120 to determine if the baseline predictive model 135 can be improved, based on the comparison performed by the processor 120 at step 235. Upon a determination by the processor 120 at step 240 that the baseline model 135 cannot be improved, the method continues at step 215 with the processor 120 receiving a training sequence 111 of video frames representative of training scene 117 from video source 108. Upon a determination by the processor 120 at step 240 that the baseline model 135 can be improved, the method continues at step 245 with the processor 120 creating a new predictive model trained as a function of the object models 132, the baseline predictive model 135, and the video frames sub-sequence. In the depicted embodiment, the video frames sub-sequence of training sequence 111 includes video frames representative of training scene 117 from video source 108. In the illustrated embodiment, training scene 117 includes visual objects representative of the homeowner's house, the homeowner's cat, a tree in the yard, and the homeowner approaching the house from the sidewalk. In the illustrated embodiment, the new predictive model is trained as a function of the visual objects including the homeowner's house, the homeowner's cat, a tree in the yard, and the homeowner. In the illustrated example, the new predictive model is trained to predict that the homeowner and the homeowner's cat are familiar and non-threatening. The method continues at step 250 with the processor 120 predicting the degree of interest and degree of confidence calculated by the new predictive model as a function of the object models 132 and their object types, and the video frames sub-sequence. The method continues at step 255 with the processor 120 comparing the predicted degree of interest and degree of confidence to thresholds predetermined as a function of the object models 132 and their object types, and historical degree of confidence data, to determine if the new predictive model is improved relative to the baseline predictive model, based on the comparison. At step 260, a test is performed by the processor 120 to determine if the new predictive model is improved relative to the baseline predictive model 135, based on the comparison performed by the processor 120 at step 255. Upon a determination by the processor 120 at step 260 that the new predictive model is not improved, the method continues at step 215 with the processor 120 receiving a training sequence 111 of video frames representative of training scene 117 from video source 108. Upon a determination by the processor 120 at step 260 that the new predictive model is improved, the method continues at step 265 with the processor 120 storing the improved new predictive model in the predictive model database 159, and providing access to the improved model to produce predictive degrees of interest and degrees of confidence determined as a function of the object models 132 and their object types, and video frames received from a video source.

FIG. 3 depicts a process flow of an exemplary Video Scene Prediction Engine (VSPE). In FIG. 3, an embodiment VSPE 141 process flow is depicted automatically governing video source operating parameters based on the degree of interest predicted by an artificial intelligence configured in the network hub 105 as a function of video frames selected by the video source. The method depicted in FIG. 3 is given from the perspective of the VSPE 141 executing as program instructions on processor 120 of network hub 105, depicted in FIG. 1. In some embodiments, the VSPE 141 may execute on cloud server 153 as a cloud service, governed by processor 120 via network cloud 150. The depicted method begins at step 305 with the processor 120 retrieving a predictive model 135 from predictive model database 159. The method continues at step 310 with the processor 120 retrieving object models 132 from the object model database 156. The method continues at step 315 with the processor 120 receiving production sequences of video frames 165 and 180, from video source 162, and video source 177, respectively. In the illustrated embodiment, the production sequences of video frames 165 and 180 are to be analyzed by the processor 120 to detect threats and objects in the sequences of video frames 165 and 180 based on artificial intelligence configured in the network hub 105. In the depicted embodiment, the processor 120 automatically governs operating parameters of the video sources 162 and 177 based on the degree of interest predicted by an artificial intelligence configured in the network hub 105 as a function of video frames selected by the video sources 162 and 177. In the depicted embodiment, the video source 162 is configured to select video frames as a function of detected motion 168 in production scene 171. In the illustrated embodiment, the video source 177 is configured to select video frames as a function of detected motion 183 in production scene 186. The method continues at step 320, with the processor 120 comparing each video frame received from the video sources 162 and 177 with at least one historical video frame, to determine if motion is detected based on the comparison. At step 325 a test is performed by the processor 120 to determine if motion was detected, based on the comparison performed by the processor at step 320. Upon a determination by the processor 120 at step 325 that motion was not detected in video frames received from video source 162 or 177, the method continues at step 315 with the processor 120 receiving production sequences of video frames from video source 162 and video source 177. Upon a determination by the processor 120 at step 325 that motion was detected in video frames received from video source 162 or 177, the method continues at step 330 with the processor 120 predicting the degree of interest calculated by the predictive model 135 as a function of the object models 132 and their object types, and a video frame sub-sequence selected based on motion detection in the sequence of video frames received from the video sources 162 and 177. The method continues at step 335 with the processor 120 comparing the predicted degree of interest to a threshold predetermined as a function of the object models 132 and their object types, to determine if the sequences of video frames are of interest, based on the comparison. In the depicted embodiment, either or both of video sources 162 or 177 may be cameras. In some embodiments, either or both of video sources 162 or 177 may be a video stream source that is not a camera. At step 340 a test is performed by the processor 120 to determine if the sequences of video frames are of interest, based on the comparison performed by the processor 120 at step 335. Upon a determination by the processor 120 at step 340 that the sequences of video frames are not of interest, the method continues at step 315 with the processor 120 receiving production sequences of video frames 165 and 180, from video source 162, and video source 177, respectively. Upon a determination by the processor 120 at step 340 that the sequences of video frames are of interest, the method continues at step 345 with the processor 120 predicting the degree of confidence calculated by the predictive model 135 as a function of the object models 132 and their object types, and the video frames sub-sequence selected based on motion detection in the sequences 165 and 180 of video frames. The method continues at step 350 with the processor 120 comparing the predicted degree of confidence to a threshold predetermined as a function of the object models 132 and the degree of interest predicted at step 330, to determine if the predicted degree of interest should be used as a basis to govern the video source operational parameters, based on the comparison. In the depicted embodiment, the video source 162 or 177 operational parameters may include on-time, bitrate, codec type, focus, pan, tilt, or zoom. In various implementations, the processor 120 may govern the video source 162 or 177 operational parameters as a function of the type of object detected by the artificial intelligence configured in the network hub 105. In some embodiments, the processor 120 may direct the video source 162 or 177 to conserve power based on cutting short the video source on-time invoked by the video source in response to motion detected by the video source. In various implementations, the processor 120 may direct a video source such as a camera to pan, tilt, or zoom in real time to follow a moving object with the camera visual field. In various designs, the processor 120 may adapt video source operational parameters as a function of detected or predicted object type. In an illustrative example, the processor 120 may adjust video source operational parameters as a function of an object classification determined by the artificial intelligence configured in the network hub 105. In some embodiments, environmental parameters may be adapted by the processor 120 as a function of image quality metrics. In some designs, environmental or video source operational parameters may be adapted by the processor 120 as a function of a degree of confidence determined by the artificial intelligence configured in the network hub 105. For example, if the degree of confidence is low relative to a threshold for an object detected as threatening, the processor 120 may increase the video bitrate or illumination to achieve a higher degree of confidence. In some embodiments, the processor 120 may send notifications of object detections to a homeowner or central server. In various designs, notifications may be filtered by the processor 120 as a function of detected object type. In an illustrative example, notification filtering conditions may be changed by the processor 120 in real time. In some designs, the processor 120 may adapt notification filtering as a function of time elapsed. For example, upon identification by the processor 120 that an object is the homeowner's cat, the processor 120 may temporarily suppress notifications to the homeowner for detections of similar cat-sized objects for a period of time. At step 355, a test is performed by the processor 120 to determine if the video source operational parameters should be governed by the processor 120 as a function of the degree of interest predicted at step 330, based on the comparison by the processor 120 at step 350. Upon a determination by the processor 120 at step 355 the video source operational parameters should not be governed by the processor 120 as a function of the degree of interest predicted at step 330, the method continues at step 315 with the processor 120 receiving production sequences of video frames 165 and 180, from video source 162, and video source 177, respectively. Upon a determination by the processor 120 at step 355 the video source operational parameters should be governed by the processor 120 as a function of the degree of interest predicted at step 330, the method continues at step 360 with the processor 120 automatically governing the video sources 162 and 177 operating parameters based on the degree of interest and degree of confidence calculated by the predictive model 135 as a function of the object models 132 and their object types, and the video frames sub-sequence selected based on motion detection in the sequences 165 and 180 of video frames received from the video sources 162 and 177. The method continues at step 315, with the processor 120 receiving production sequences of video frames 165 and 180, from video source 162, and video source 177, respectively.

Although various embodiments have been described with reference to the Figures, other embodiments are possible. For example, in some embodiments, battery powered cameras may be managed with artificial intelligence configured in a local hub to intelligently manage camera power consumption. In some scenarios of exemplary usage, battery powered security cameras may provide a multitude of benefits to users including ease of setup and ease of distribution. In various examples of use, battery powered security cameras are a popular way to provide visibility around a home. In an illustrative example, a camera if connected to an intelligent WiFi hub may manage the power consumption with a higher degree of accuracy than a camera without AI, or a camera running AI on the camera, or a camera running AI in the cloud.

In some embodiments, a set of cameras (and potentially other sensors) may be connected to an intelligent Wifi hub. In various implementations, machine learning may be performed on this hub which in some designs may be both the network connectivity hub of the camera and a processor designed to perform AI. In an illustrative example, the hub may be designed to have sufficient computational power (including a GPU) to perform the AI with very low latency (<0.1 s) so that every frame can be evaluated for its potential security concern. In an illustrative example of exemplary usage, such low-latency AI evaluation of potential security concern may allow a very precise management of power. For example, the low-latency AI may determine that it is only a cat entering the area of interest, and that there are no people within the frame, so to disregard this particular event.

In an illustrative scenario exemplary of prior art usage without AI, battery life may be very short—for example the Netgear Arlo Pro has a very short battery life (<10 days in areas of lots of motion). In some exemplary prior art scenarios, AI on cameras (such as cameras plugged into a wall) may consume excessive power. For example, running a simple AI filter on a battery-powered camera would more than double (or more likely 10×) the power consumption of the camera—having a direct and proportional impact on its battery life. In an illustrative example, cloud-based AI may be both too slow and too expensive to perform real-time analysis for all motion events for a battery powered camera (each frame must be analyzed in real-time [<100 ms] to determine if the camera should stay on). In some embodiments, AI may be configured to identify relevant objects within the field of view of battery powered cameras. In various implementations, every frame may be economically analyzed for interesting things in the field of a camera. In some exemplary scenarios of use, analyzing every frame in the cloud for interesting things in the field of a camera may be prohibitively expensive for most consumers.

In some exemplary usage scenarios of various embodiments, irrelevant events may be quickly and intelligently filtered if they do not contain objects of interest as identified by an AI (e.g., identify people, dogs, etc.); or identify the specific residents of a home, further reducing power consumption based on management of the camera's power and filtering events and notifications based on the identification by the AI. In some embodiments, the AI may be customized to the individual home while protecting privacy. In various implementations, an embodiment distributed AI may be customized to recognize the residents of a particular home without ever sharing the images of these homeowners to the cloud, based on, for example, methods for distributed training of artificial intelligence to recognize objects in video while protecting privacy as described with reference to FIGS. 1-6 of U.S. patent application Ser. No. 15/491,950, entitled “Distributed Deep Learning Using a Distributed Deep Neural Network,” filed by Selinger, David Lee, et al., on Apr. 19, 2017 the entire contents of which are herein incorporated by reference. In some designs, battery-powered cameras may be configured to run object tracking on the camera. In some examples, an object to be tracked may be configured in the camera by the network hub. In some examples, object tracking on the camera may result in increased camera energy efficiency as a result of sending only events related to objects of interest to the network hub from the camera. Various implementations may be useful in home security to protect the perimeter of homes.

In some embodiments, event filtering conditions may be determined as a function of the type of an identified or tracked object. In some examples, the type of object may be determined by artificial intelligence configured in a network hub based on video frames or images received by the hub from a camera. In an illustrative example of exemplary usage, prior art cameras may turn on for a fixed period of time under two filtering conditions: 1. Motion detector activation for a period of time or with a certain first derivative; and, 2. Motion in area-of-interest of camera. In some embodiments, a real time AI as described with reference to FIGS. 1-4 of U.S. patent application Ser. No. 15/492,011, entitled “System and Method for Event Detection Based on Video Frame Delta Information in Compressed Video Streams,” filed by Selinger, David Lee, et al., on Apr. 20, 2017 the entire contents of which are herein incorporated by reference, may be configured to quickly determine the type of a moving object. In an illustrative example, object type may be “cat”, “dog”, or “son”. Such exemplary real-time moving object type determination may create various benefits. For example, in some embodiments, in response to type of object detected by AI in the hub, the system may cut-short the camera fixed on-time, saving battery. In some designs, object type information may also be used to filter notifications to the owner.

In various embodiments, ambient or environmental conditions such as illumination may be adapted in real-time based on evaluation of image quality, to improve detection capability based on improvement in image quality. In exemplary scenarios of prior art use, some current cameras may set the illumination level according to an ambient light sensor. In some embodiments illumination may be changed in real-time based on evaluation of image quality metrics. For example, in some embodiments, illumination may be increased or decreased in real-time as a function of type of object information.

In some embodiments, bitrate may be adapted in real-time based on evaluation of image quality, to improve detection capability based on improvement in image quality. In exemplary scenarios of prior art use, some current cameras may set the bitrate level according to the codec or video profile information. In some embodiments bitrate may be changed in real-time based on evaluation of image quality metrics. For example, in some embodiments, bitrate may be increased or decreased in real-time as a function of type of object information.

In various designs, AI for camera management at the hub may be cheaper than in the cloud. In some embodiments, AI for camera management at the hub may be faster than AI in the cloud. In an illustrative example of exemplary prior art usage, cloud services may not be optimized for real-time performance, as they do not run real-time operating systems (RTOS OR RTOSES). In some examples of the prior art, cloud services cannot be configured with RTOSES because they are virtualized. In an illustrative example of a virtualized cloud service, the OS inside the Virtual Machine (VM) calls to the underlying OS, which is never an RTOS because to be an RTOS would require one VM to be able to exclude other VMs from access to hardware, which is not now possible.

In various designs, such real-time AI-based camera management may advantageously provide the opportunity to control actuators or other outputs in real-time in response to events or objects detected by the AI in video or images received by the hub. For example, in some embodiments, actuators or other outputs controlled in real-time in response to events or objects detected by the AI in video or images received by the hub may include a pan-and-tilt following a burglar detected by the AI.

In some embodiments, filtering conditions may be changed in real time. In exemplary scenarios of usage, prior art cameras may not be able to change their filtering conditions in real-time. In some examples, prior art cameras may not, for example, adapt filtering conditions to ignore objects that are not of interest; the best they could conceivably do is to send the information to the web and be one (1) second behind real-time. In some embodiments, an exemplary AI-managed camera may detect that the object in the field of view is a cat and so for the next 10 minutes, we will not trigger on cat-sized objects.

In various exemplary scenarios of prior art usage, battery powered cameras are not configured with AI. In some exemplary scenarios of prior art usage, cameras configured with AI may typically have wired power. In some illustrative scenarios or prior art usage, excessive battery drain may result from running AI on a battery powered camera.

Some embodiments may include Artificial Intelligence (AI) configured in a network hub communicatively and operatively coupled with a wireless camera. In some designs, cameras communicatively and operatively coupled with the network hub may be Common Off The Shelf (COTS) cameras.

In some implementations, the network hub may include more than one network connection. In some embodiments, the network hub may include a Wi-Fi connection. In various designs, the network hub may include a wired power connection. In some examples, the network hub may include a wired connection to the network. In various designs, cameras may stream video frames or images to the hub. In various designs, more than one AI may be configured in the hub. In some examples, various AIs configured in the hub may be adapted to detect a diversity of various objects. In some examples, the hub may be configured to direct cameras, for example, a hub may be configured to control the position or orientation of a camera through pan, tilt, or zoom operations directed by the hub. In some designs, the hub may be configured to reboot or control cameras. In various implementations, the hub may be adapted to maintain the health of cameras; for example, the hub may be configured to send an alert if a camera goes offline, or predict when a camera battery will need to be replaced and send a battery change alert. In some examples, the hub may be configured to control a camera to focus on objects in the visual field of the camera. In exemplary scenarios of prior art usage, controlling a camera to focus on objects in the visual field of the camera cannot be done after the camera captures the images; for example, the hub may be configured to control camera focus, lighting, and bitrate changes, in response to image quality metrics evaluated by the AI configured in the hub. In some designs, the AI configured in the hub may determine specifics about object including identifying specific individuals. In some examples, the hub may be adapted with a High Dynamic Range (HDR) imaging feature usable in real time. For example, in illustrative examples of prior art usage, useful real-time HDR may not be possible due to latency in the cloud. In some embodiments, the real-time cloud latency limitation of the prior art failure to provide useful real-time HDR may be overcome as a result of providing a local hub adapted with an HDR feature. In some examples, camera video feeds may be 30 frame/sec, 60 frame/sec, or faster. Some embodiments may respond with useful object detection or AI predictions or decisions within one to two frames, based on deltas or differences between frames. In an exemplary scenario illustrative of the response time of cloud-based systems, prior art response times may be in the range of several seconds or longer. In some examples of illustrative usage scenarios, fast response times may be important for security purposes. Some embodiments may advantageously provide detection response times an order of magnitude faster and more accurate. In an illustrative example, if someone turns their head into a camera's visual field only for a quick moment, the event could be missed in the latency of cloud system, however an embodiment hub system would not lose the imagery. In various implementations, a hub system may identify specific objects, such as, for example, a specific cat, a specific dog, or a specific human. For example, an embodiment hub system may be fast and accurate enough to identify the difference between a homeowner's dog and a random dog. In some embodiments, the AI configured in the hub may be personalized for various places, for example, in a specific home, the AI may be configured to expect certain specific objects.

In an illustrative example according to an embodiment of the present invention, the system and method are accomplished through the use of one or more computing devices. As depicted in FIG. 1, one of ordinary skill in the art would appreciate that an exemplary network hub 105 appropriate for use with embodiments of the present application may generally be comprised of one or more of a Central processing Unit (CPU) which may be referred to as a processor, Random Access Memory (RAM), a storage medium (e.g., hard disk drive, solid state drive, flash memory, cloud storage), an operating system (OS), one or more application software, a display element, one or more communications means, or one or more input/output devices/means. Examples of computing devices usable with embodiments of the present invention include, but are not limited to, proprietary computing devices, personal computers, mobile computing devices, tablet PCs, mini-PCs, servers or any combination thereof. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In various embodiments, communications means, data store(s), processor(s), or memory may interact with other components on the computing device, in order to effect the provisioning and display of various functionalities associated with the system and method detailed herein. One of ordinary skill in the art would appreciate that there are numerous configurations that could be utilized with embodiments of the present invention, and embodiments of the present invention are contemplated for use with any appropriate configuration.

According to an embodiment of the present invention, the communications means of the system may be, for instance, any means for communicating data over one or more networks or to one or more peripheral devices attached to the system. Appropriate communications means may include, but are not limited to, circuitry and control systems for providing wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While some of the foregoing drawings and description set forth functional aspects of some embodiments of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, Python, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are exemplary, and provided for illustrative disclosure of enablement and exemplary best mode of various embodiments. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

Many suitable methods and corresponding materials to make each of the individual parts of embodiment apparatus are known in the art. According to an embodiment of the present invention, one or more of the parts may be formed by machining, 3D printing (also known as “additive” manufacturing), CNC machined parts (also known as “subtractive” manufacturing), and injection molding, as will be apparent to a person of ordinary skill in the art. Metals, wood, thermoplastic and thermosetting polymers, resins and elastomers as described herein-above may be used. Many suitable materials are known and available and can be selected and mixed depending on desired strength and flexibility, preferred manufacturing method and particular use, as will be apparent to a person of ordinary skill in the art.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. An apparatus, comprising:
a power management module, comprising: a network hub configured with an artificial intelligence adapted to govern operational parameters of a device connected to the hub based on objects detected by the artificial intelligence as a function of video frames received from the connected device; and,
a camera, operatively and communicatively coupled with the power management module, the camera adapted to transmit to the power management module video frames selected as a function of a video characteristic detected by the camera.

2. The apparatus of claim 1, wherein the camera further comprises a wireless network interface.

3. The apparatus of claim 1, wherein the camera is a battery-powered camera.

4. The apparatus of claim 1, wherein the network hub further comprises a GPU.

5. The apparatus of claim 1, wherein the video characteristic detected by the camera further comprises motion.

6. The apparatus of claim 1, wherein the network hub further comprises artificial intelligence adapted to determine the type of object detected as a function of video frames received from the connected device.

7. The apparatus of claim 6, wherein the operational parameters further comprise on-time adapted as a function of object type.

8. The apparatus of claim 6, wherein the operational parameters further comprise bitrate adapted as a function of object type.

9. The apparatus of claim 6, wherein the power management module further comprises operably coupled illumination controlled by the power management module as a function of an image quality metric.

10. The apparatus of claim 6, wherein the power management module further comprises the network hub adapted to transmit to a homeowner notifications filtered in real time as a function of the type of object detected.

11. An apparatus, comprising:
a power management module, comprising: a network hub configured with an artificial intelligence adapted to govern operational parameters of a device connected to the hub based on a detected object type determined by the artificial intelligence as a function of video frames received from the connected device; and,
a camera, operatively and communicatively coupled with the power management module, the camera adapted to transmit to the power management module video frames selected as a function of motion detected by the camera.

12. The apparatus of claim 11, wherein the camera is a battery-powered camera.

13. The apparatus of claim 11, wherein the network hub further comprises a GPU configured with sufficient computational power to perform the AI as a function of each video frame received from the connected device in no more than 0.1 sec per frame.

14. The apparatus of claim 11, wherein the operational parameters further comprise on-time governed as a function of the detected object type.

15. The apparatus of claim 11, wherein the operational parameters further comprise bit-rate governed as a function of the detected object type.

16. The apparatus of claim 11, wherein the power management module further comprises the network hub adapted to transmit to a homeowner notifications filtered in real time as a function of the type of object detected.

17. An apparatus, comprising:
a power management module, comprising: a network hub configured with an artificial intelligence adapted to govern operational parameters of a device connected to the hub based on a detected object type determined by the artificial intelligence as a function of video frames received from the connected device; and,
a camera, operatively and communicatively coupled with the power management module, the camera adapted to:
pan, tilt, focus, or zoom as directed by the power management module; and, transmit to the power management module video frames selected as a function of motion detected by the camera.

18. The apparatus of claim 17, wherein the camera further comprises object detection configured in the camera by the power management module.

19. The apparatus of claim 17, wherein the power management module further comprises the network hub adapted to pan, tilt, focus, or zoom the camera as a function of the detected object.

20. The apparatus of claim 17, wherein the power management module further comprises the network hub adapted to transmit to a homeowner notifications filtered in real time as a function of the type of object detected.
